(19) United States
(12) Patent Application Publication
(10) Pub. No.: US 2011/0244743 A1
(43) Pub. Date: Oct. 6, 2011

(54) PROCESS FOR PRODUCING FIBER-REINFORCED COMPOSITE MATERIALS USING POLYAMIDES AS BINDERS

(75) Inventors: Dietrich Scherzer, Neustadt (DE); Philippe Desbois, Edingen-Neckarhausen (DE); Uwe Gleiter, Neustadt (DE); Martin Weber, Maikammer (DE); Michael Gall, Neustadt (DE)

(73) Assignee: BASF SE, Ludwigshafen (DE)

(21) Appl. No.: 13/076,722

(22) Filed: Mar. 31, 2011

Related U.S. Application Data
(60) Provisional application No. 61/319,901, filed on Apr. 1, 2010.

(51) Int. Cl. B32B 5/02; C09D 177/02; B29C 70/30

(52) U.S. Cl. 442/59; 524/606; 524/608; 264/258

(57) ABSTRACT

Process for producing fiber-reinforced composite materials, by

a) molding a textile structure and then spray-applying a binder, or saturating the textile structure with a binder, or
b) first spray-applying a binder to a textile structure, or saturating a textile structure with a binder, and then subjecting the material to forming and drying.

### CROSS-REFERENCE TO RELATED APPLICATIONS

This application claims the benefit (under 35 USC 119(e)) of U.S. Provisional Application 61/319,901, filed Apr. 1, 2010 which is incorporated by reference.

### BACKGROUND OF THE INVENTION

The present invention relates to binders for the preforming process to which textile structures are subjected when structural materials are produced by the RIM or RTM method, where the binder composed of an amorphous polyamide is spray applied in a solvent onto the textile structure or onto the textile, and is used as binder for the preforming process.

A known process for producing fiber-reinforced sandwich components based on pourable polyamide uses what is known as the RTM (resin-transfer-molding) method. In this method, the core is arranged, with layers arranged thereon composed of dry fiber material, i.e. fiber material that has not been preimpregnated, in a mold that can be closed. The mold is composed of two heatable mold halves, the internal shape of which corresponds to the external shape of the finished component. Within the closed mold cavity, liquid resin is introduced into the dry fiber material. The resin is hardened via heating of the mold. Either superatmospheric pressure or vacuum can be used here for introducing the resin into the RTM mold. The respective pressure difference serves inter alia to avoid undesired air inclusions in the outer layer. Various disadvantages of prepreg technology are avoided by using dry scrims. EP-A-722 825 discloses the RTM method that uses superatmospheric pressure within the mold. Corresponding RTM methods proposing vacuum within the mold are known from EP-A-770 472, EP-A-786 330, and EP-A-1 281 505. WO-A-02/074469 discloses an RTM method in which resin is injected under superatmospheric pressure and the process is assisted by generating a vacuum within the gas-tight closed mold. However, these processes, too, have the attendant disadvantage of high purchase costs and high operating costs. One of the problems is that each type of component requires a specific, expensive heatable RTM mold.

In the description of the present invention, as in the literature, the expression “RIM method (RIM=reaction injection molding) is often used synonymously with RTM method.

However, the abovementioned processes are not entirely satisfactory.

It was therefore an object of the present invention to overcome the abovementioned disadvantages.

### BRIEF SUMMARY OF THE INVENTION

Said object is achieved in technical terms by providing a process which uses polymerization of lactams in molds, with addition of textile structures, to produce fiber-composite moldings which are in essence sheet-like.

The present invention provides a process for producing fiber-reinforced composite materials, using polyamides as binders.

The process of the invention can improve the reproducibility of the technological properties of the material of the molding, via controlled introduction of textile structures that have been subjected to a preforming process. Among these properties are by way of example tensile strength, modulus of elasticity, impact resistance, and the like. For the purposes of the invention, textile structures are not only rovings, wovens, knits, and mats, but also nonwovens and felts; in advantageous embodiments of the invention these are therefore needlefelts, wovens, rovings, woven rovings, and mats, preferably made of glass fibers, carbon fibers, or synthetic fibers. The process involved therefore produces three-dimensional long-fiber-reinforced structural components based on pourable polyamides, on epoxy resins, or on polyurethane resins. The textile structure (fiber mat) used here can be subjected to a preforming process prior to processing.

For the preforming process, the textile can be sprayed with a solution of the amorphous polyamide (or of any other soluble thermoplastic), and the solvent can be evaporated. Ultramid® 1C in ethanolic solution has excellent compatibility with polyamide matrices and has particular suitability as sprayable coating composition and sprayable binder for fibers and textiles. The coating composition/binder exhibits very little or no inhibiting effect on pourable polyamides.

If the spray is applied to the textile after it has been subjected to a preforming process, it remains in the mold after evaporation of the solvent. However, the textiles thus treated can also be subjected to a forming process in a second step (preferably) via heating. The forming process can be carried out in the injection mold, or else in an upstream step.

By way of example, Kunststoffhandbuch “Duroplaste 10” [Plastics Handbook “Thermosets 10”] Hanserverlag 1988, on p. 825ff discloses processes for producing structural components.

Accordingly, a novel and improved process has been found for producing fiber-reinforced composite materials, and is characterized by

a) molding a textile structure and then spray-applying a binder, or saturating the textile structure with a binder, or
b) first spray-applying a binder to a textile structure, or saturating a textile structure with a binder, and then subjecting the material to forming and drying.

### DETAILED DESCRIPTION OF THE INVENTION

The textile that has been subjected to a preforming process can, after drying of the binder, either be left in the heated mold or introduced into the final polymerization mold, where, in the processes described, the caprolactam can be introduced together with the activators and catalysts; it saturates the textile structure and hardens.

The polymerization reaction can be carried out at mold temperatures of from 100 to 190° C., and, if appropriate, the postpolymerization reaction can be carried out at temperatures of from 80 to 150° C.

### Sequence of Processing Steps:

1. cutting the textile(s) to shape
2. placing the textiles in the premold or RTM mold, and possibly carrying out a preforming process
3. introducing dissolved thermoplastic in the form of spray
4. evaporating solvent
5. closing the mold
6. preforming-process step
7. removing the textile component and transfer to RTM mold or further processing within the mold.

The preforming process described, using sprayable thermoplastics, is particularly simple and inexpensive, and is therefore suitable for long runs. The process of the invention can be carried out as follows:

In one preferred embodiment, operations can follow what is known as the RTM (resin-transfer-molding) method or the RIM (reaction-injection-molding) method. In these methods, the core can be arranged, with layers arranged thereon made of dried textile structures comprising binder, in a mold that can be closed. The mold is generally composed of two heatable mold halves, the internal shape of which corresponds to the external shape of the finished components. Within the closed mold cavity, molten lactam, with the additives required for the polymerization reaction, can be introduced into the dry fiber material that has been subjected to a preforming process. The lactam can be hardened via heating of the mold. The resin here can be introduced at atmospheric pressure into the RTM mold or RIM mold, or preferably at a pressure of from 1.1 to 20 bar, preferably from 1.5 to 5 bar, particularly preferably from 1.0 to 3.0 bar, or at a pressure of from 0.001 to 0.9 bar, preferably from 0.1 to 0.8 bar, particularly preferably from 0.2 to 0.6 bar.

Suitable binders are soluble polyamides, examples being amorphous polyamides, e.g. mixtures which do not readily crystallize and which are composed of nylon-6 and nylon-6,6, of polyamide derived from hexamethylenediamine and isophthalic acid (nylon-6,I), other suitable binders being other amorphous polyamides, or in general terms any of the soluble polyamides, but preferably amorphous mixtures made of aliphatic polyamides, and particularly preferably Ultramid® 1C from BASF SE, based on a mixture of nylon-6 and nylon-6,6.

Suitable solvents for the soluble polyamides are water, alkanols, e.g. C₁-C₂₀ alkanols, e.g. methanol, ethanol, n-propanol, isopropanol, n-butanol, isobutanol, tert-butanol, n-pentanol, isopentanol, n-hexanol, isohexanol, n-heptanol, isoheptanol, n-octanol, isooctanol, and ketones, e.g. acetone, methyl ethyl ketone, and esters, e.g. ethyl acetate, and halogenated solvents, e.g. methylene chloride, chloroform, and carbon tetrachloride, or a mixture of these, preferably water, C₁-C₈ alkanols, e.g. methanol, ethanol, n-propanol, isopropanol, n-butanol, isobutanol, sec-butanol, tert-butanol, n-pentanol, isopentanol, n-hexanol, isohexanol, n-heptanol, isoheptanol, n-octanol, isooctanol, or a mixture of these, particularly preferably water, C₁-C₄ alkanols, e.g. methanol, ethanol, n-propanol, isopropanol, n-butanol, isobutanol, sec-butanol, tert-butanol, or a mixture of these.

Suitable textile structures are wovens, nonwovens, and scrims based on carbon fibers, on glass fibers, on aramid fibers, on natural fibers, or on a mixture of these, preferably glass fibers, carbon fibers, or aramid fibers, particularly preferably glass fibers and carbon fibers.

Suitable thermosets are pourable polyamides, which here are the polymers derived from caprolactam and laurolactam, or a mixture of these. ε-Caprolactam is preferably suitable as lactam.

Up to 20% by weight, i.e. from 0 to 20% by weight, preferably from 0 to 17% by weight, particularly preferably from 0 to 15% by weight, of the caprolactam can be replaced by comonomers from the group of the lactams having at least 4 carbon atoms, particular preference being given to ω-laurolactam.

One preferred embodiment can use a mixture of ε-caprolactam and ω-laurolactam. The mixing ratio is generally 1000:1, preferably 100:1, particularly preferably 10:1, in particular 2:1.

Other suitable starting materials for nylon-6 are activators which can be produced via reaction of isocyanates, such as HDI (hexamethylene diisocyanate) with lactams, such as ε-caprolactam, and other suitable starting materials are capped isocyanates, isophthaloylbiscaprolactam, terephthaloylbiscaprolactam, esters, e.g. dimethyl phthalate polyethylene glycol, polyols, or polydienes, in combination with acyl chlorides, carbonylbiscaprolactam, hexamethylene diisocyanate, or acyl lactamate, and preferred starting materials are isocyanates, hexamethylene diisocyanate, or acyl lactamate, particularly preferably hexamethylene diisocyanate, or acyl lactamate, and alkaline catalysts, e.g. magnesium halide lactamates, alkali metal caprolactamates, aluminum lactam or magnesium lactam, sodium caprolactamate, or magnesium bromide lactamate, preferably alkali metal caprolactamates, aluminum lactam or magnesium lactam, sodium caprolactamate, or magnesium bromide lactamate, particularly preferably sodium caprolactam or magnesium bromide lactamate.

Activators used can be any of the activators used for activated anionic polymerization reactions, examples therefore being N-acyllactams, e.g. N-acetylcaprolactam, substituted triazines, carbodimides, cyanamides, mono- and polyisocyanates, and the corresponding capped isocyanate compounds. The concentrations preferably used of the activators are from 0.1 to 1 mol %, based on the amount of lactam. By using the catalysts of the invention it is possible to polymerize lactams having at least 5 ring members, e.g. caprolactam, laurolactam, caprylolactam, or enantholactam, or the corresponding carbon-substituted lactams, or a mixture of the lactams mentioned.

The alkaline catalysts can be produced via reaction of the polyether with the corresponding alkali metal compound or the corresponding alkaline earth metal compound, e.g. with the alkylate, amide, hydride, or Grignard compounds, or else with the alkali metals or alkaline earth metals. The amounts generally used of the catalysts are from 0.1 to 40% by weight, preferably from 0.2 to 15% by weight, based on the lactam melt.

Catalysts with good suitability for the polymerization reaction are potassium lactamates or sodium lactamates. Sodium caprolactamate has particularly good suitability and can easily be produced from NaH and ε-caprolactam.

The mixing ratio of caprolactam, activator, and alkaline catalyst can be varied widely, but the molar ratio of caprolactam to activator to alkaline catalyst is generally from 1000:1:1 to 1000:200:50.

Suitable fibers are inorganic materials, such as high-modulus carbon fibers, silicatic and nonsilicatic glasses of a very wide variety of types, carbon, boron, silicon carbide, metals, metal alloys, metal oxides, metal nitrides, metal carbides, and silicates, and also organic materials, e.g. natural and synthetic polymers, for example polyacrylonitriles, polyesters, ultrastretched polyolefin fibers, polyamides, polyimides, aramids, liquid-crystal polymers, polyphenylene sulfides, polyether ketones, polyether ether ketones, polyetherimides, cotton, cellulose, and other natural fibers, e.g. flax, sisal, kenaf, hemp, and abaca, but preferably high-melting-point materials, e.g. glass, carbon, aramids, liquid-crystal polymers, polyphenylene sulfides, polyether ketones, polyether ether ketones, and polyetherimides, and particularly preferably glass fibers, carbon fibers, aramid fibers, steel fibers, ceramic fibers, and/or other sufficiently heat-resistant polymeric fibers, or filaments.

Suitable reinforcing material comprises rovings of the abovementioned fibers, preferably non-linear, and linear, particularly preferably sheet-like moldings, e.g. fibers, yarns, and textile structures, examples being wovens, knits, braids, and nonwovens.

The content of fibers in the finished composite material is generally from 20 to 85% by volume, preferably from 40 to 70% by volume, or in the case of profiles with purely monodirectional reinforcement from 30 to 90% by volume, preferably from 40 to 80% by volume.

The reinforcing material can have uniform distribution within the composite material of the invention, but its proportion present in certain portions of the composite material, e.g. in the peripheral regions, and/or in particular reinforcement zones, can also be greater than in other portions of the composite material.

The term composite material means materials made of two or more materials bonded together, examples being particulate composite materials (dispersion materials), fiber-composite materials, laminates, and interpenetration-composite materials, preferably fiber-composite materials and laminates, and particularly preferably fiber-composite materials.

The composite-material components produced in the invention are suitable for use as shell for safety helmets which provide head-protection for persons driving a motor vehicle or motorcycle.

### EXAMPLES

The textiles or textile structures used to reinforce the components are either preinserted into the mold, saturated with the binder, and subjected to a performing process via closure of the mold and evaporation of the solvent, where the activated and catalyzed lactam is injected, or are subjected to a performing process in a second heated mold, and then introduced into the polymerization mold.

### Inventive Example 1

5 layers of a 5×90/10 glass fiber mat (producer: Saertex) (weight per unit area 424 g/m²) were inserted into the mold (hat mold), and molded manually to the shape, and 50 ml of a solution made of 10% by weight of Ultramid® 1C (BASF SE) in ethanol/water, ratio 9:1 by volume was sprayed onto the material. After drying to remove the solvent at from 30 to 150° C., the mold was closed and, at a mold temperature of 150° C., filled with a pourable polyamide based on caprolactam from Brüggemann (Heilbronn). The catalyst used comprised Brüggolene C10, and the activator used comprised Brüggolene C20. The low-water-content caprolactam used was likewise from Brüggemann (AP-Nylon® Caprolactam). The activator and catalyst were used in accordance with the data sheet. The molding was removed after 4 minutes.

The resultant molding was perfect, with no surface defects.

### Comparative Example A

The 5×90/10 glass fiber mats (produced by Saertex) (weight per unit area 424 g/m²) used for reinforcement were inserted into the mold (hat mold), and molded by hand to the shape. At a mold temperature of 150° C., the mold was filled, as described above, with a pourable polyamide system from Brüggemann (Heilbronn).

The inserted textiles had slipped out of place, and surface defects made the quality of the component unsatisfactory.

1-10. (canceled)

11. A process for producing fiber-reinforced composite materials, by
a) molding a textile structure and then spray-applying a binder, or saturating the textile structure with a binder, or
b) first spray-applying a binder to a textile structure, or saturating a textile structure with a binder, and then subjecting the material to forming and drying.

12. A binder for the preforming process used on textile structures when producing structural materials by the reaction injection molding (RIM) or resin transfer molding (RTM) method, wherein the binder composed of an amorphous polyamide is spray-applied in a solvent or in a solvent mixture onto the textile structure or onto the textile, and is used as binder for the preforming process.

13. The binder according to claim 12, wherein the binder composed of an amorphous polyamide is spray-applied in an aqueous alcoholic solution onto the textile structure of the textile, and is used as binder for the preforming process, where this can take place in one or two stages.

14. The binder according to claim 12, based on polyamide blends comprising nylon-6 or nylon-6,6.

15. The binder according to claim 13, based on polyamide blends comprising nylon-6 or nylon-6,6.

16. The binder according to claim 12, based on Ultramid® C.

17. The binder according to claim 12, based on a solution of the polyamide or polyamides in a water/ethanol or water/propanol solution.

18. A process for producing composite materials by the RTM or RIM method, utilizing the binders according to claim 12.

19. A composite-material component produced by a process according to claim 11.

20. A shell for a safety helmet which comprises the composite-material component according to claim 19.
